(19) United States
(12) Patent Application Publication
(10) Pub. No.: US 2016/0372878 A1
(43) Pub. Date: Dec. 22, 2016

(54) HOT MELT INSULATION FIXING PLATE AS WELL AS A PLUG AND A SOCKET USING THAT HOT MELT INSULATION FIXING PLATE

(71) Applicant: Chuan-Sheng WANG, Tainan City (TW)

(72) Inventor: Chuan-Sheng WANG, Tainan City (TW)

(21) Appl. No.: 14/743,271

(22) Filed: Jun. 18, 2015

(51) Int. Cl. H01R 24/70; H01R 13/46; H01R 24/78

(52) U.S. Cl. CPC H01R 24/70; H01R 24/78; H01R 13/46

(57) ABSTRACT

A hot melt insulation fixing plate, along with a plug and a socket using the hot melt insulation fixing plate are disclosed. The hot melt insulation fixing plate forms contact limit between two conductive members to constitute a closed path, and enables the two conductive members to be opened by an elastic force to form an open circuit when the hot melt fixing plate is damaged by overheat. The hot melt insulation fixing plate includes an insulative annular sleeve being sheathed on the two conductive members and having two opposite stopping parts and two opposite connecting parts that connect the two stopping parts. The two stopping parts and the two connecting parts commonly define a holding space to contain the two conductive members, forming contact limit between the two conductive members. The hot melt insulation fixing plate is further applied to overheat protection for a plug and a socket.

### BACKGROUND OF THE INVENTION

(a) Field of the Invention

The present invention relates to a hot melt insulation fixing plate as well as a plug and a socket using that hot melt insulation fixing plate. The hot melt insulation fixing plate is a fixing plate for combination and is used to form contact limit between two conductive members, thereby constituting a closed path. In addition, the hot melt insulation fixing plate is damaged when overheat, forming an open circuit between the two conductive members by an elastic force. The present invention further applies the hot melt insulation fixing plate to overheat protection for a plug and a socket.

(b) Description of the Prior Art

To prevent a circuit from the occurrence of current overload, short circuit or overheat, the circuit is usually provided with a wire fuse or a circuit breaker. When the temperature of the circuit is too high or the current is too large, the wire fuse can be melted and fractured by high temperature or a metallic spring leaf of the circuit breaker can be ejected by the large current, which causes the circuit to form an open circuit to power off, thereby keeping the safe use of electricity.

Regarding to a prior art related to the wire fuse structure, there is a Taiwanese Invention Patent Publication No. 1371053, “Thermal Fuse Connecting Structure.” The thermal fuse connecting structure includes primarily two terminals which are connected together to form a closed path, and a piece of hot melt metal which is combined on the two terminals. Under the condition of current overload, circuit overheat or that an ambient temperature of use is too high, the hot melt metal will be melted and fractured by the rise of temperature, which causes the two terminals not to be connected with each other, thereby forming an open-circuit state.

However, in the prior art, the hot melt metal is made of a conductive material. Therefore, when the hot melt metal is melted and fractured, if part of the hot melt metal is adhered on the two terminals, the adhered hot melt metal may easily result in false contact between the two terminals, so that the circuit cannot power off completely. In addition, the hot melt metal that is melted and fractured can be ejected by the two opened terminals to form an open circuit, and the hot melt metal that is melted and fractured may hit with other object to form false contact and result in short circuit, which is still dangerous in use.

Accordingly, the present inventor has applied for a Taiwanese utility model patent publication No. M477079, “Overheat Failure Safety Structure, as well as a Socket and a Plug with the Overheat Failure Safety Structure.” This patent discloses the use of an insulation stopper to connect two conductive members, thereby forming a closed path. When the circuit is overheated, the insulation stopper will be melted and fractured, allowing the two conductive members to be opened by an elastic force to form an open circuit. The stopper is provided with a first insulation part and an opposite second insulation part, and a connecting part is used to connect the first insulation part with the second insulation part, which forms a U-shaped appearance.

Upon a practical application, it is found that as the U-shaped stopper may not have sufficient rigidity of connection, even that the closed path between the two conductive members is not overheated, the U-shaped stopper may still be ejected by the elastic force between the two conductive members as the force of constraint is reduced by heat, thereby forming an open circuit between the two conductive members. On the other hand, when the temperature between the two conductive members is too high, the first insulation part and the second insulation part of the U-shaped stopper will be ejected by the elastic force between the two conductive members. However, as the connecting part is still connected with the first insulation part and the second insulation part, the U-shaped stopper will maintain a portion of the force of constraint that the two conductive members remain partly contact and the circuit cannot power off completely. These two abovementioned conditions can all be a false action that may be happened.

### SUMMARY OF THE INVENTION

Accordingly, to solve the abovementioned false action that may be happened to the stopper, the present invention further discloses a hot melt insulation fixing plate.

The hot melt insulation fixing plate forms contact limit between two conductive members to constitute a closed path, and is damaged when overheat, which allows the two conductive members to be opened by an elastic force, thereby forming an open circuit.

The hot melt insulation fixing plate includes an insulative annular sleeve which is sheathed on the two conductive members. The insulative annular sleeve is provided with two opposite stopping parts and two opposite connecting parts that connect the two stopping parts. The two stopping parts and the two connecting parts commonly define a holding space which is used to contain the two conductive members, thereby forming contact limit between the two conductive members. At least one of the two connecting parts is in the thickness of 0.1˜1.2 cm.

Furthermore, at least one of the two connecting parts is in the thickness of 0.7 cm.

Furthermore, the thickness of each stopping part is not smaller than the thickness of any connecting part.

Furthermore, a middle section of at least one of the two connecting parts is formed with an indented concave part, and the thickness at the location of the concave part of at least one of the two connecting parts is between 0.1 cm and 1.2 cm.

Furthermore, an end part of at least one of the two stopping parts is formed with a guide-in part which enlarges gradually.

Furthermore, an exterior side of at least one of the two stopping parts is formed with a protruded abutting part.

The present invention also discloses a plug that uses the abovementioned hot melt insulation fixing plate.

The plug includes an insulative body, a live wire pin, a neutral wire pin, a live wire, a neutral wire, and an insulative annular sleeve. The live wire pin is disposed inside the insulative body and extends out of the insulative body. The neutral wire pin is disposed inside the insulative body and extends out of the insulative body. The live wire corresponds to the live wire pin and the neutral wire corresponds to the neutral wire pin. The insulative annular sleeve is provided with two opposite stopping parts and two opposite connecting parts to connect the two stopping parts. The two stopping parts and the two connecting parts commonly define a holding space, and at least one of the two connecting parts is in the thickness of 0.1˜1.2 cm. By sheathing the insulative annular sleeve on the live wire pin and the live wire, the live wire pin can contact with the live wire to form a closed path. And, by sheathing the insulative annular sleeve on the neutral wire pin and the neutral wire, the neutral wire pin can contact with the neutral wire to form a closed path. The insulative annular sleeve is damaged when overheat, such that the live wire pin will be opened relative to the live wire, and the neutral wire pin will be opened relative to the neutral wire by an elastic force between the live wire pin and the live wire as well as between the neutral wire pin and the neutral wire, thereby forming an open circuit.

Furthermore, at least one of the abovementioned two connecting parts is in the thickness of 0.7 cm, and the thickness of each of the abovementioned two stopping parts is no less than the thickness of any one of the two connecting parts. A middle section of at least one of the two connecting parts is formed with an indented concave part, and the thickness at the location of the concave part of at least one of the two connecting parts is between 0.1 cm and 1.2 cm. An end part of at least one of the two stopping parts is formed with a guide-in part which enlarges gradually, and an exterior side of at least one of the two stopping parts is formed with a protruded abutting part.

Furthermore, the live wire pin extends along a same direction as the direction along which the live wire extends, and the neutral wire pin extends along a same direction as the direction along which the neutral wire extends.

Furthermore, the extension direction of the live wire pin is perpendicular to the extension direction of the live wire, and the live wire pin or the live wire is provided with a bent extension plate; whereas, the insulative annular sleeve is sheathed on that bent extension plate. The extension direction of the neutral wire pin is perpendicular to the extension direction of the neutral wire, and the neutral wire pin or the neutral wire is provided with a bent extension plate; whereas, the insulative annular sleeve is sheathed on that bent extension plate.

The present invention further discloses a socket that uses the abovementioned hot melt insulation fixing plate.

The socket includes an insulative body, a live wire terminal, a neutral wire terminal, a live wire, a neutral wire, and an insulative annular sleeve. The insulative body is provided with a least a set of opposite live wire receptacle and neutral wire receptacle. The live wire terminal is disposed inside the insulative body and corresponds to the live wire receptacle. The neutral wire terminal is disposed inside the insulative body and corresponds to the neutral wire receptacle. The live wire corresponds to the live wire terminal, and the neutral wire corresponds to the neutral wire terminal. The insulative annular sleeve is provided with two opposite stopping parts and two opposite connecting parts to connect the two stopping parts. The two stopping parts and the two connecting parts commonly define a holding space, and at least one of the two connecting parts is in the thickness of 0.1˜1.2 cm. By sheathing the insulative annular sleeve on the live wire terminal and the live wire, the live wire terminal can contact with the live wire to form a closed path. And, by sheathing the insulative annular sleeve on the neutral wire terminal and the neutral wire, the neutral wire terminal can contact with the neutral wire to form a closed path. The insulative annular sleeve is damaged when overheat, such that the live wire terminal will be opened relative to the live wire, and the neutral wire terminal will be opened relative to the neutral wire by an elastic force between the live wire terminal and the live wire as well as between the neutral wire terminal and the neutral wire, thereby forming an open circuit

Furthermore, at least one of the abovementioned two connecting parts is in the thickness of 0.7 cm, and the thickness of each of the abovementioned two stopping parts is no less than the thickness of any one of the two connecting parts. A middle section of at least one of the two connecting parts is formed with an indented concave part, and the thickness at the location of the concave part of at least one of the two connecting parts is between 0.1 cm and 1.2 cm. An end part of at least one of the two stopping parts is formed with a guide-in part which enlarges gradually, and an exterior side of at least one of the two stopping parts is formed with a protruded abutting part.

The present invention is provided with following functions that:
1. The hot melt insulation fixing plate of the present invention is made of an insulative material. Therefore, when the hot melt insulation fixing plate is melted and damaged due to the overheat to the protected circuit, the insulation property of the hot melt insulation fixing plate can prevent the circuit from contacting with peripheral electronic elements by accidents to cause short circuit, so as to assure the safety after the circuit powers off.
2. The abovementioned insulative annular sleeve constitutes a sealed configuration by the connection of two stopping parts and two connecting parts. Therefore, there is sufficient rigidity of connection to assemble and position the two conductive members of the protected circuit, such that in normal use, the two conductive members will not be ejected by the elastic force between the two conductive members to cause a false action.
3. The thickness of the two stopping parts of the abovementioned insulative annular sleeve is not smaller than the thickness of any one of the two connecting parts, which assures to provide sufficient rigidity of connection.
4. The abovementioned insulative annular sleeve is in an annularly sealed configuration, which can assure that two stopping parts can be ejected completely by the elastic force between the two conductive members when the insulative annular sleeve is heated and melted. Therefore, the two conductive members can separate with each other and be opened relative to each other actually to power off the circuit, unlike that in the prior art, as one end of the U-shaped stopper is opened, when that end is ejected by the two conductive members, the other end will still keep a portion of the force of constraint, allowing the two conductive members to be partly restrained and limited that the circuit will not power off completely.
5. At least one of the two connecting parts of the abovementioned insulative annular sleeve is provided with at least a thickness of 0.1˜1.2 cm, preferably 0.7 cm. Therefore, when the protected circuit is heated up to about 130° C. to 140° C., the extent that the insulative annular sleeve is melted by heat can assure that the two conductive members are ejected by the elastic force, which assures that the protected circuit will power off actually.
6. An end part of at least one of the two stopping parts of the abovementioned insulative annular sleeve is formed with the guide-in part that enlarges gradually, which facilitates sheathing the insulative annular sleeve on the two conductive members.
7. An exterior side of at least one of the two stopping parts of the abovementioned insulative annular sleeve is formed with the protruded abutting part, which facilitates a user to use a tool, such as pliers, to exert a force onto the abutting part to sheath the insulative annular sleeve on the two conductive members.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of an insulative annular sleeve in a first embodiment of the present invention.

FIG. 2 shows a three-dimensional exploded view of sheathing the insulative annular sleeve on two conductive members, in the first embodiment of the present invention.

FIG. 3 shows a schematic view of an operation to sheath the insulative annular sleeve on the two conductive members, in the first embodiment of the present invention.

FIG. 4 shows a three-dimensional assembly view of sheathing the insulative annular sleeve on the two conductive members, in the first embodiment of the assembly.

FIG. 5 shows a three-dimensional assembly view of sheathing the insulative annular sleeve on the two conductive members on another direction, in the first embodiment of the assembly.

FIG. 6 shows a schematic view of sheathing the insulative annular sleeve on the two conductive members to form contact limit between the two conductive members, in the first embodiment of the present invention.

FIG. 7 shows a front view of that when the protected circuit is overheated that the insulative annular sleeve is melted and a force of constraint is reduced, the two conductive members are opened by an elastic force, in the first embodiment of the present invention.

FIG. 8 shows a three-dimensional view of that when the protected circuit is overheated that the insulative annular sleeve is melted and the force of constraint is reduced, the two conductive members are opened by the elastic force, in the first embodiment of the present invention.

FIG. 9 shows a front view of that when the protected circuit is overheated that the insulative annular sleeve is melted and fractured, the two conductive members are opened by the elastic force, in the first embodiment of the present invention.

FIG. 10 shows a three-dimensional view of that when the protected circuit is overheated that the insulative annular sleeve is melted and fractured, the two conductive members are opened by the elastic force, in the first embodiment of the present invention.

FIG. 11 shows a schematic view of that the insulative annular sleeve is provided with a guide-in part to facilitate sheathing the insulative annular sleeve on the two conductive members, in a second embodiment of the present invention.

FIG. 12 shows a cutaway view of that the insulative annular sleeve is provided with a guide-in part to facilitate sheathing the insulative annular sleeve on the two conductive members, in the second embodiment of the present invention.

FIG. 13 shows a schematic view of that the insulative annular sleeve is provided with a protruded abutting part, in a third embodiment of the present invention.

FIG. 14 shows a schematic view of using a tool to abut the abutting part to facilitate sheathing the insulative annular sleeve on the two conductive members, in the third embodiment of the present invention.

FIG. 15 shows a schematic view of a connecting part which is provided with a concave part, in the fourth embodiment of the present invention.

FIG. 16 shows an entire schematic view of using the hot melt insulation fixing plate of the present invention in a plug, wherein a live wire pin extends along a same direction as the direction along which a live wire extends, and a neutral wire pin extends along a same direction as the direction along which a neutral wire extends.

FIG. 17 shows an entire schematic view of using the hot melt insulation fixing plate of the present invention in the plug, wherein the live wire pin extends along a direction perpendicular to the direction along which the live wire extends, and the neutral wire pin extends along a direction perpendicular to the direction along which the neutral wire extends.

FIG. 18 shows a partial schematic view of using the hot melt insulation fixing plate of the present invention in the plug, wherein the live wire pin extends along a direction perpendicular to the direction along which the live wire extends, and the neutral wire pin extends along a direction perpendicular to the direction along which the neutral wire extends.

FIG. 19 shows a first schematic view of using the hot melt insulation fixing plate of the present invention in a socket.

FIG. 20 shows a second schematic view of using the hot melt insulation fixing plate of the present invention in the socket.

### DETAILED DESCRIPTION OF THE PREFERRED EMBODIMENTS

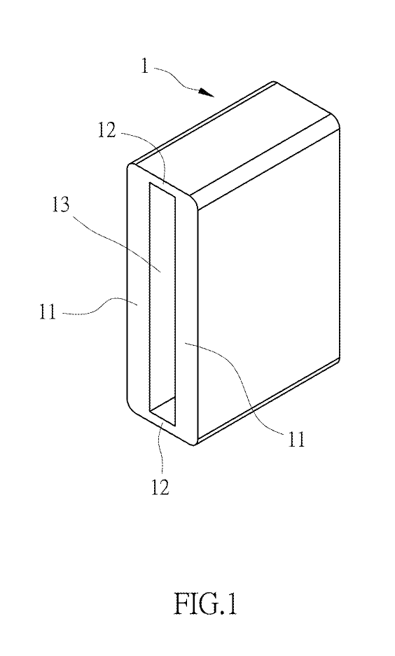

Please refer to FIG. 1 for a first embodiment of the present invention. An insulation fixing plate of the present embodiment comprises an insulative annular sleeve 1 which is provided with two opposite stopping parts 11 and two opposite connecting parts 12 that connect the two stopping parts 11. The two stopping parts 11 and the two connecting parts 12 commonly define a holding space 13. The thickness of the two connecting parts 12 is between 0.1 cm and 1.2 cm, and is 0.7 cm for the present embodiment. In addition, the thickness of the stopping part 11 is not smaller than the thickness of any one of the two connecting parts 12.

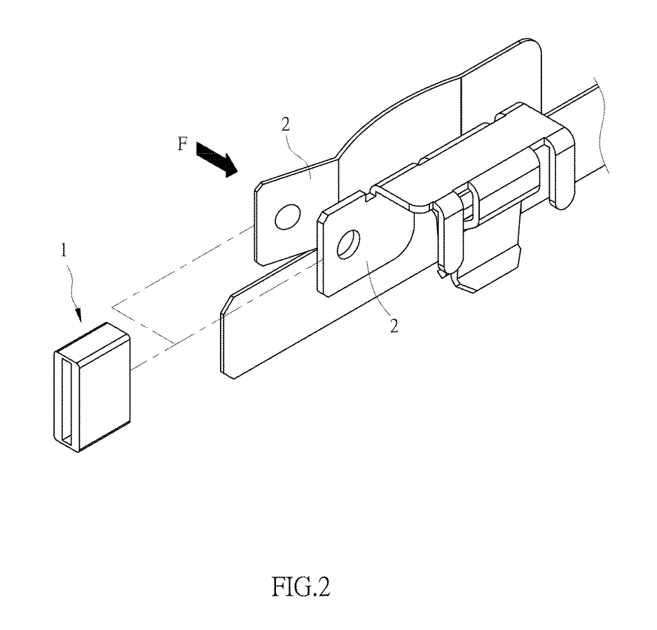

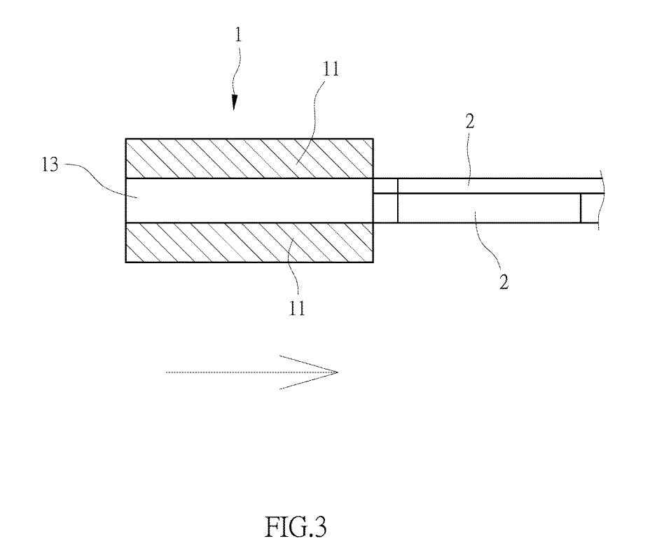

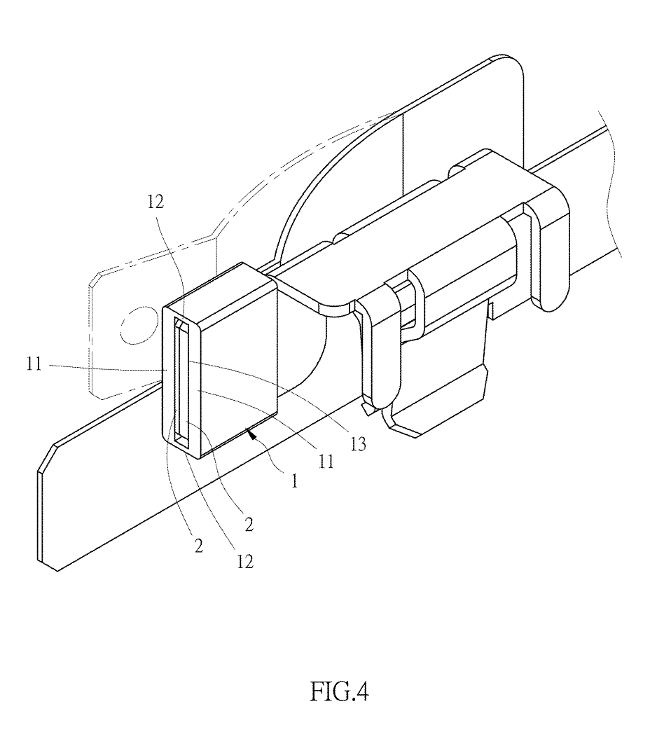

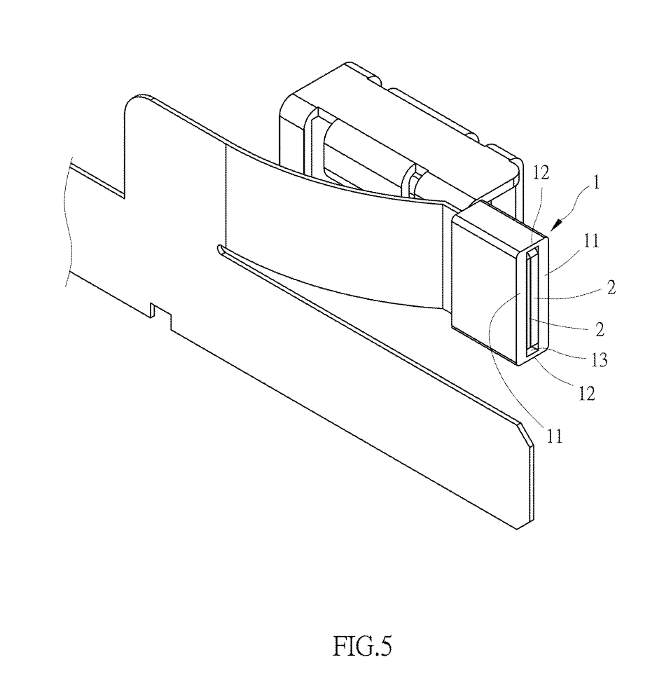

Referring to FIGS. 2 to 5, the insulative annular sleeve 1 is sheathed on two conductive members 2 of the protected circuit, wherein the two conductive members 2 are separated and do not contact with each other in an initial state. First, an external force F is applied to enable the two conductive members 2 to approach to and contact with each other, and then, the insulative annular sleeve 1 is sheathed on the two conductive members 2. When the insulative annular sleeve 1 is sheathed on the two conductive members 2 that the two conductive members 2 are contained in the holding space 13, the two stopping parts 11 will attach and abut to the two conductive members 2 respectively, thereby compressing the two conductive members 2 to store an elastic force, and allowing the two conductive members 2 to form contact limit with each other to constitute a closed path.

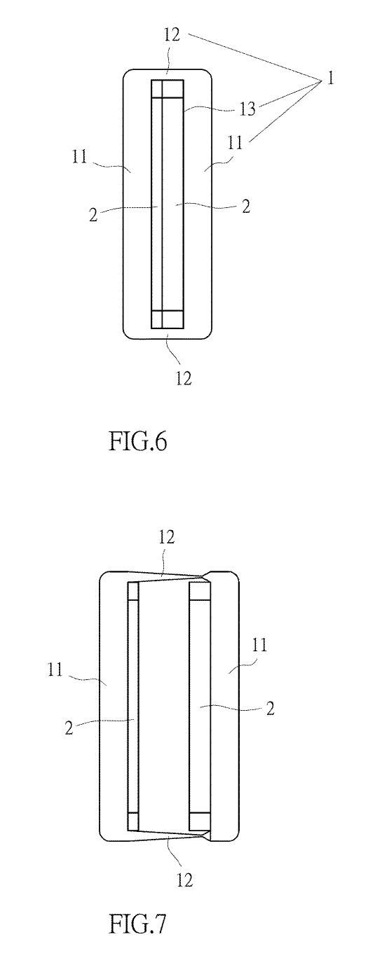

Referring to FIG. 6, in the present invention, a sealed state is constituted by connecting the two stopping parts 11 and the two connecting parts 12, therefore there will be sufficient rigidity of connection to assemble and position the two conductive members 2 of the protected circuit. In normal use, the insulative annular sleeve 1 will not be ejected by the elastic force between the two conductive members 2 to cause a false action, and the fact that the thickness of the abovementioned two stopping parts 11 is not smaller than the thickness of any one of the two connecting parts 12 also assures to provide sufficient rigidity of connection.

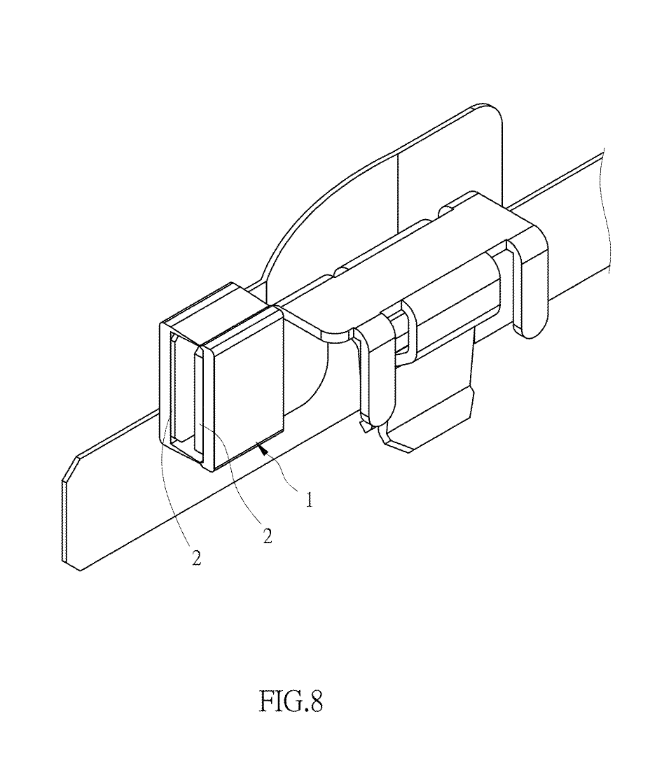

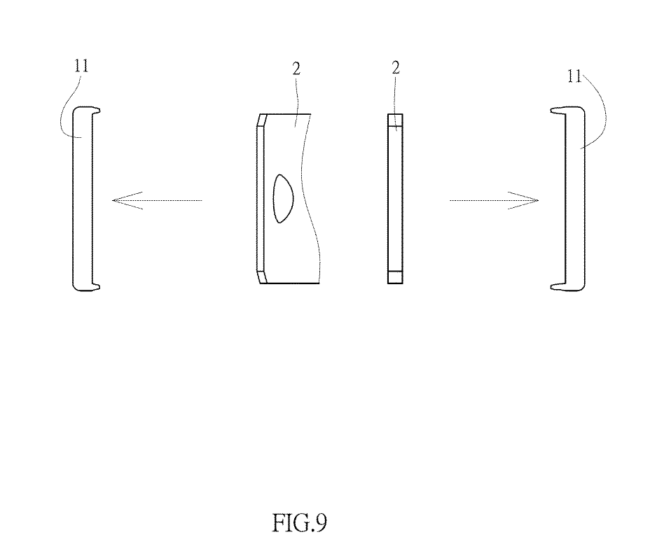

Referring to FIG. 7 and FIG. 8, when there is current or voltage overload in the protected circuit that the two conductive members 2 are overheated, such as when the temperature rises up to about 130° C. or 140° C., the insulative annular sleeve 1 will be melted and softened by the heat, which reduces a force of constraint. At this time, the elastic force between the two conductive members 2 will be released, allowing the two conductive members 2 to be opened and forming an open circuit, which will prevent from overheat to induce fire. The fact that the thickness of the two connecting parts 12 is between 0.1 cm and 1.2 cm is to assure that when the two connecting parts 12 are overheated and softened, the elastic force between the two conductive members 2 is sufficient to overcome the force of constraint, thereby ejecting the two connecting parts 12. In addition, the insulative annular sleeve 1 is in an annularly sealed configuration, and two ends of the two stopping parts 11 are all connected with the connecting parts 12. Therefore, when the insulative annular sleeve 1 is heated and melted, two ends of the two stopping parts 11 can be assured to be ejected uniformly by the elastic force of the two conductive members 2, such that the two conductive members 2 can be separated and opened actually to power off the circuit.

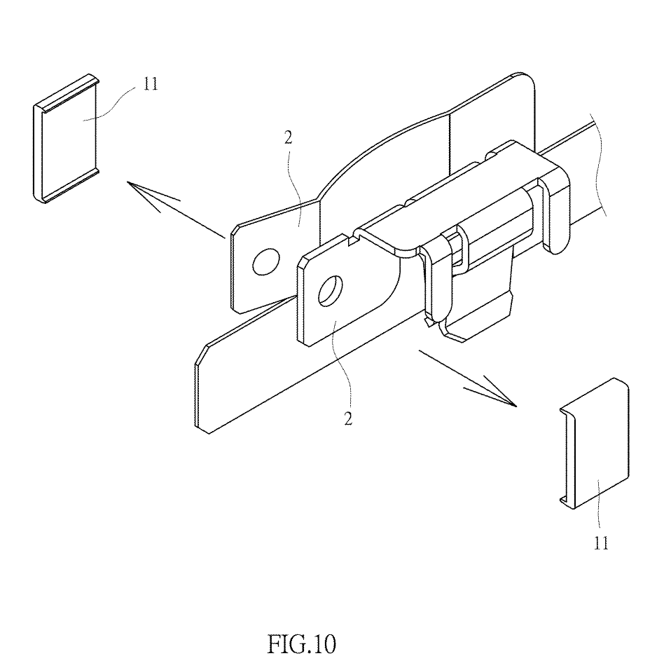

Referring to FIG. 9 and FIG. 10, as the insulative annular sleeve 1 is made of an insulative material, even the insulative annular sleeve 1 is fractured by being melted down to eject randomly, the insulation property of the insulative annular sleeve 1 can prevent the circuit from false contacting with peripheral electronic elements by accidents to cause short circuit, thereby assuring the safety after the circuit powers off. In FIG. 9 and FIG. 10, as the insulative annular sleeve 1 has been fractured and ejected, the complete configuration of the insulative annular sleeve 1 is referred to in FIG. 1.

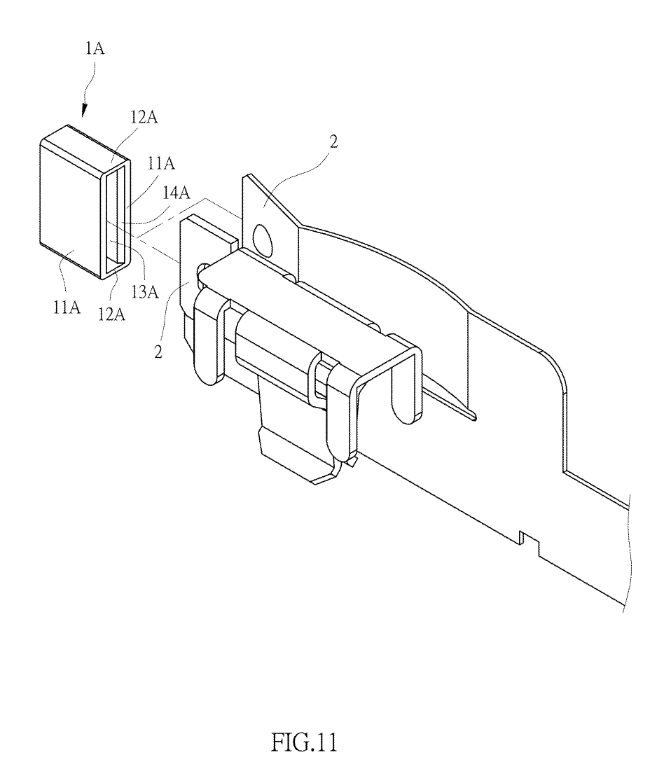

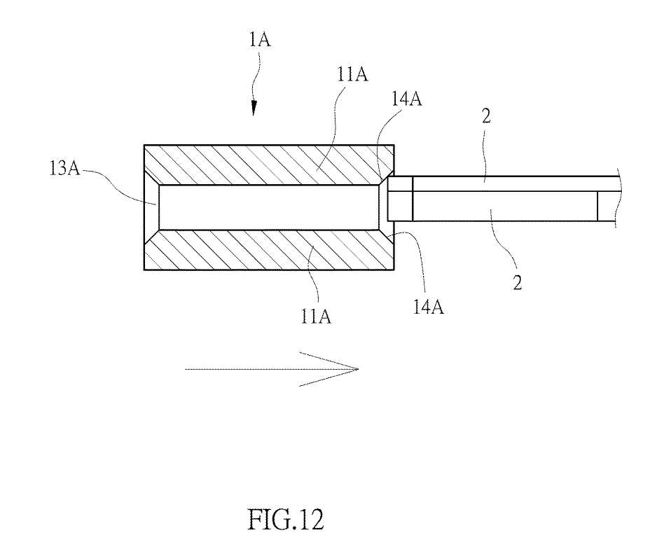

Please refer to FIG. 11 and FIG. 12 for a second embodiment of the present invention. An insulation fixing plate of the present embodiment comprises an insulative annular sleeve 1A which is provided with two opposite two stopping parts 11A and two opposite connecting parts 12A that connect the two stopping parts 11A. The two stopping parts 11A and the two connecting parts 12A commonly define a holding space 13A. The thickness of the two connecting parts 12A is between 0.1 cm and 1.2 cm, and is 0.7 cm for the present embodiment. The thickness of each stopping part 11A is not smaller than the thickness of any one of the two connecting parts 12A. Unlike the first embodiment, an end part of at least one of the two stopping parts 11A is formed with a guide-in part 14A which enlarges gradually. The guide-in part 14A is used to facilitate a user to guide the two conductive members 2 into the holding space 13A of the insulative annular sleeve 1A.

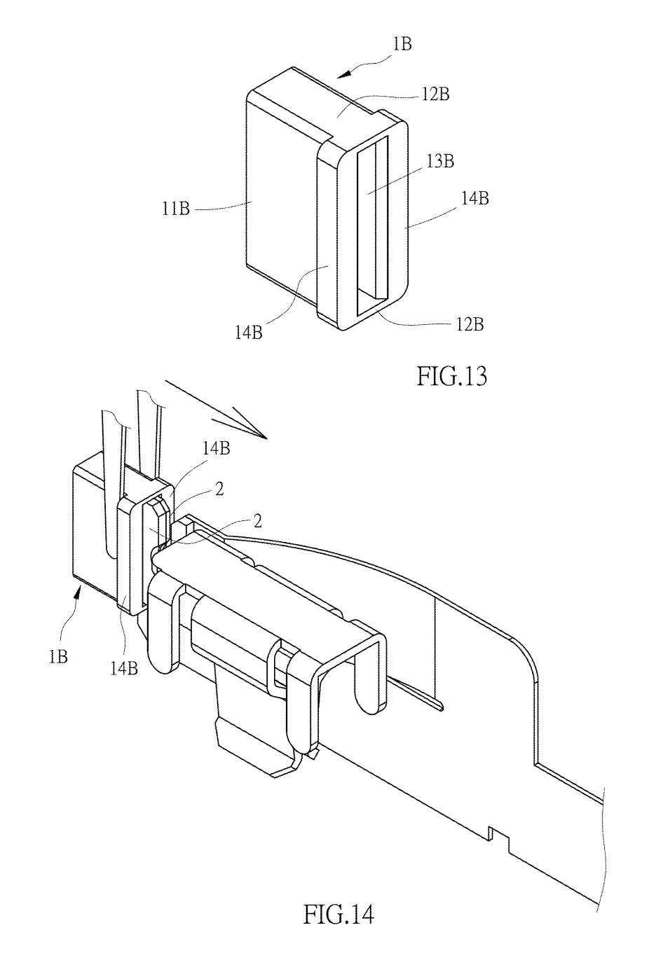

Please refer to FIG. 13 and FIG. 14 for a third embodiment of the present invention. An insulation fixing plate of the present embodiment comprises an insulative annular sleeve 1B which is provided with two opposite stopping parts 11B and two opposite connecting parts 12B that connect the two stopping parts 11B. The two stopping parts 11B and the two connecting parts 12B commonly define a holding space 13B. The thickness of the two connecting parts 12B is between 0.1 cm and 1.2 cm, and is 0.7 cm for the present embodiment. The thickness of each stopping part 11B is not smaller than the thickness of any one of the two connecting parts 12B. Unlike the first embodiment, an exterior side of at least one of the two stopping parts 11B is formed with a protruded abutting part 14B. The abutting part 14B is used to facilitate the user to use a tool, such as pliers, to exert a force onto the abutting part 14B, sheathing the insulative annular sleeve 1B on the two conductive members 2.

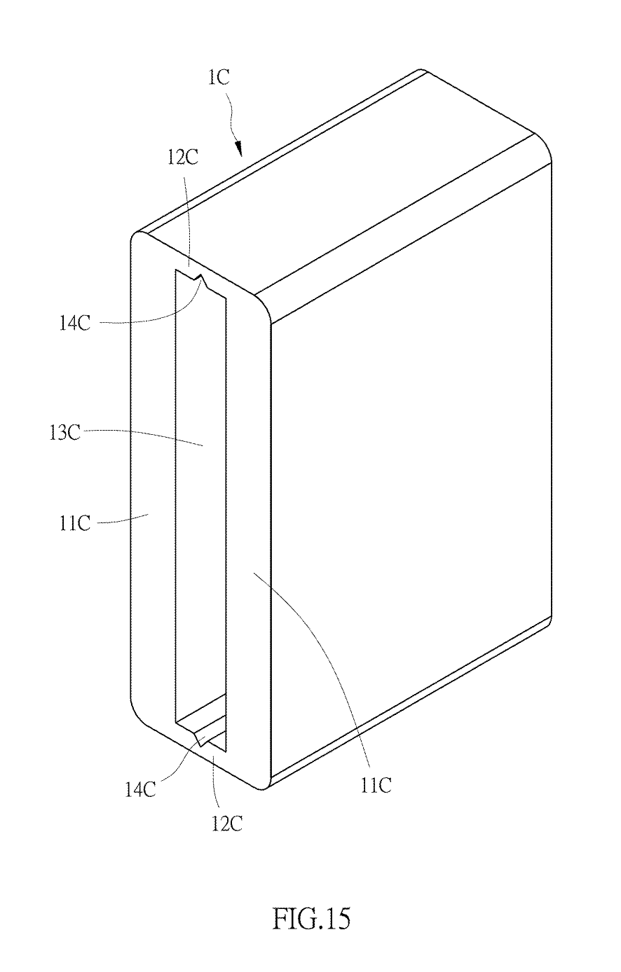

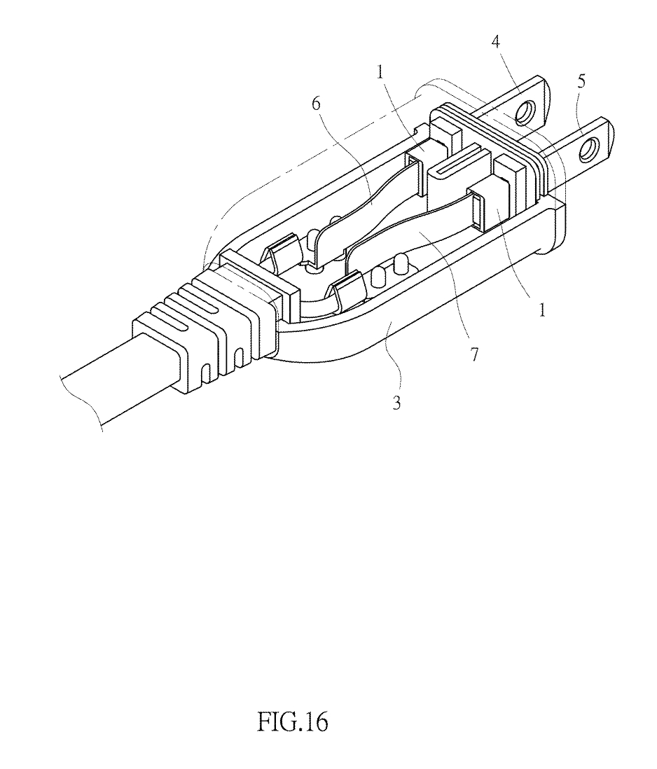

Please refer to FIG. 15 for a fourth embodiment. An insulation fixing plate of the present embodiment comprises an insulative annular sleeve 1C which is provided with two opposite stopping parts 11C and two opposite connecting parts 12C that connect the two stopping parts 11C. The two stopping parts 11C and the two connecting parts 12C commonly define a holding space 13C. The thickness of the two connecting parts 12C is between 0.1 cm and 1.2 cm, and is 0.7 cm for the present embodiment. The thickness of each stopping part 11C is not smaller than the thickness of any one of the two connecting parts 12C. In the present embodiment, a middle section of each connecting part 12C is formed with an indented concave part 14C which faces the other connecting part 12C. The thickness at the location of the concave part 14C of the connecting part 12C is between 0.1 cm and 1.2 cm. It should be pointed out that in this embodiment, the configuration of the two connecting parts 12C can change freely, as long as there is a partial thickness of 0.1˜1.2 cm and then the function of the present invention can be achieved.

Referring to FIG. 16, the hot melt insulation fixing plate of the present invention is applied to overheat protection for a plug, using the hot melt insulation fixing plate of the first embodiment as an example. The present embodiment comprises an insulative body 3, a live wire pin 4 which is disposed inside the insulative body 3 and extends out of the insulative body 3, a neutral wire pin 5 which is disposed inside the insulative body 3 and extends out of the insulative body 3, a live wire 6 which corresponds to the live wire pin 4, and a neutral wire 7 which corresponds to the neutral wire pin 5. The live wire pin 4 extends along a same direction as the direction along which the live wire 6 extends, and the neutral wire pin 5 extends along a same direction as the direction along which the neutral wire 7 extends.

By sheathing the insulative annular sleeve 1 on the live wire pin 4 and the live wire 6, the live wire pin 4 can contact with the live wire 6 to form a closed path. And, by sheathing the insulative annular sleeve 1 on the neutral wire pin 5 and the neutral wire 7, the neutral wire pin 5 can contact with the neutral wire 7 to form a closed path. The insulative annular sleeve 1 will be melted when overheat, which allows the live wire pin 4 to be opened relative to the live wire 6, and the neutral wire pin 5 to be opened relative to the neutral wire 7 by an elastic force between the live wire pin 4 and the live wire 6 as well as between the neutral wire pin 5 and the neutral wire 7, thereby forming an open circuit to achieve the effect of overheat protection.

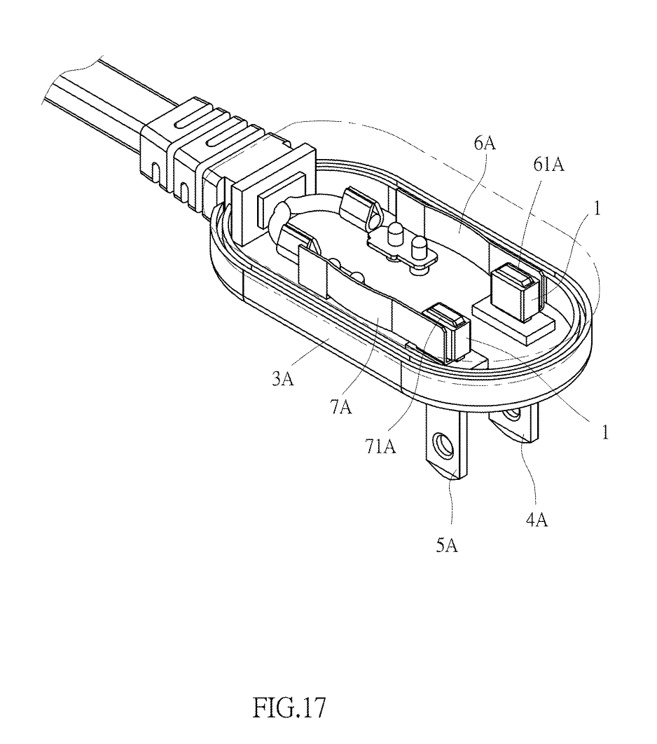

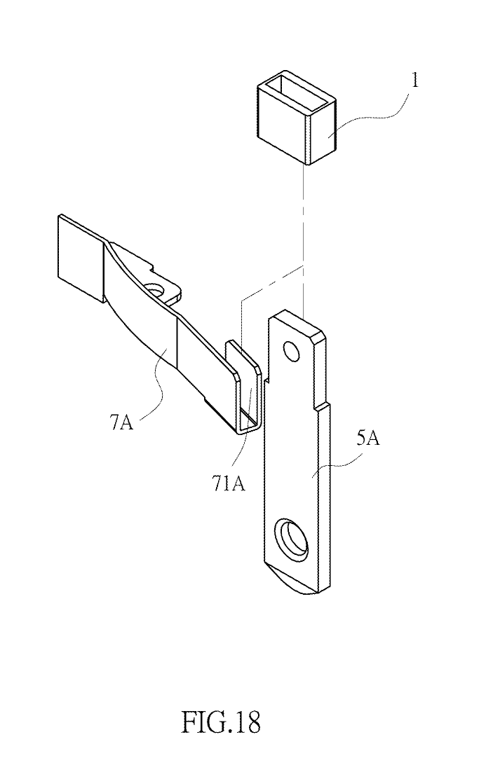

Referring to FIG. 17 and FIG. 18, in addition to being applied to the abovementioned plug, the hot melt insulation fixing plate can be also applied to another kind of plug. This plug includes an insulative body 3A, a live wire pin 4A which is disposed inside the insulative body 3A and extends out of the insulative body 3A, a neutral wire pin 5A which is disposed inside the insulative body 3A and extends out of the insulative body 3A, a live wire 6A which corresponds to the live wire pin 4A, and a neutral wire 7A which corresponds to the neutral wire pin 5A. The live wire pin 4A extends along a direction perpendicular to the direction along which the live wire 6A extends, and the live wire 6A is provided with a bent extension plate 61A. The insulative annular sleeve 1 is sheathed on the bent extension plate 61A and the live wire pin 4A. The neutral wire pin 5A extends along a direction perpendicular to the direction along which the neutral wire 7A extends, and the neutral wire 7A is provided with a bent extension plate 71A. The insulative annular sleeve 1 is sheathed on the bent extension plate 71A and the neutral wire pin 5A. It means that the live wire pin 4A, the live wire 6A, the neutral wire pin 5A or the neutral wire 7A can be bent into a proper configuration to fit with the insulative annular sleeve 1.

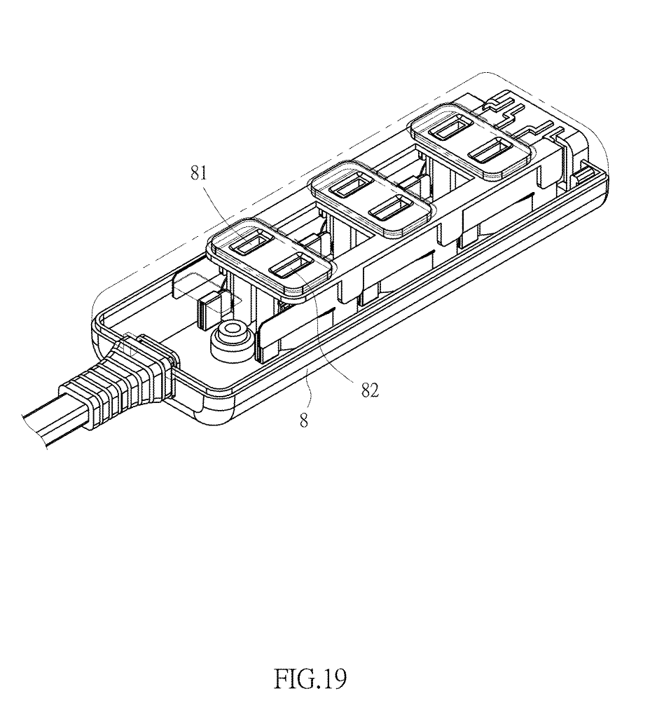

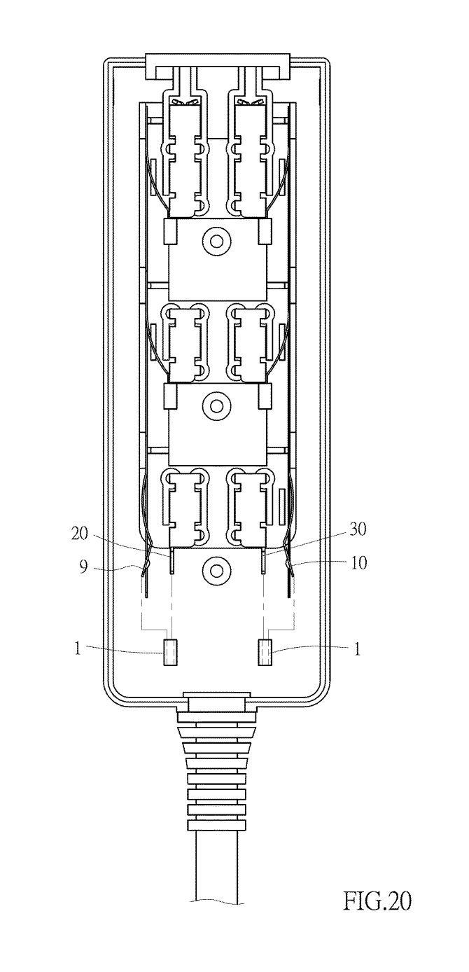

Referring to FIG. 19 and FIG. 20, the hot melt insulation fixing plate of the present invention is applied to overheat protection for a socket, using the hot melt insulation fixing plate of the first embodiment as an example. The present embodiment comprises an insulative body 8 which is provided with at least a set of opposite live wire receptacle 81 and neutral wire receptacle 82, a live wire terminal 9 which is disposed inside the insulative body 8 and corresponds to the live wire receptacle 81, a neutral wire terminal 10 which is disposed inside the insulative body 8 and corresponds to the neutral wire receptacle 82, a live wire 20 which corresponds to the live wire terminal 9, and a neutral wire 30 which corresponds to the neutral wire terminal 10.

By sheathing the insulative annular sleeve 1 on the live wire terminal 9 and the live wire 20, the live wire terminal 9 can contact with the live wire 20 to form a closed path. And, by sheathing the insulative annular sleeve 1 on the neutral wire terminal 10 and the neutral wire 30, the neutral wire terminal 10 can contact with the neutral wire 30 to form a closed path. The insulative annular sleeve 1 is melted when overheat, such that the live wire terminal 9 can be opened relative to the live wire 20, and the neutral wire terminal 10 can be opened relative to the neutral wire 30 by an elastic force between the live wire terminal 9 and the live wire 20 as well as between the neutral wire terminal 10 and the neutral wire 30, thereby forming an open circuit to achieve the effect of overheat protection.

It is to be understood that the above description and drawings are only used for illustrating some embodiments of the present invention, not intended to limit the scope thereof. Any variation and deviation from the above description and drawings should be included in the scope of the present invention.

What is claimed is:

1. A hot melt insulation fixing plate, being used to form contact limit between two conductive members to constitute a closed path, and being damaged when overheat to allow the two conductive members to be opened by an elastic force to form an open circuit, the hot melt insulation fixing plate comprising an insulative annular sleeve which is sheathed on the two conductive members and is provided with two opposite stopping parts and two opposite connecting parts that connect the two stopping parts, with the two stopping parts and the two connecting parts commonly defining a holding space to contain the two conductive members and to form contact limit between the two conductive members, and the thickness of one of the two connecting parts being between 0.1 cm and 1.2 cm.

2. The hot melt insulation fixing plate according to claim 1, wherein the thickness of one of the two connecting parts is 0.7 cm.

3. The hot melt insulation fixing plate according to claim 1, wherein the thickness of each stopping part is not smaller than the thickness of each connecting part.

4. The hot melt insulation fixing plate according to claim 1, wherein a middle section of one of the two connecting parts is formed with an indented concave part, and the thickness at the location of the concave part of the connecting part is between 0.1 cm and 1.2 cm.

5. The hot melt insulation fixing plate according to claim 1, wherein an end part of one of the two stopping parts is formed with a guide-in part which enlarges gradually.

6. The hot melt insulation fixing plate according to claim 1, wherein an exterior side of one of the two stopping parts is formed with a protruded abutting part.

7. A plug using the hot melt insulation fixing plate according to claim 1, comprising an insulative body, a live wire pin which is disposed inside the insulative body and extends out of the insulative body, a neutral wire pin which is disposed inside the insulative body and extends out of the insulative body, a live wire which corresponds to the live wire pin, a neutral wire which corresponds to the neutral wire pin, and an insulative annular sleeve, with that the insulative annular sleeve is provided with two opposite stopping parts and two opposite connecting parts to connect the two stopping parts, the two stopping parts and the two connecting parts commonly define a holding space, and at least one of the two connecting parts is in the thickness of 0.1˜1.2 cm; by sheathing the insulative annular sleeve on the live wire pin and the live wire, the live wire pin contacting with the live wire to form a closed path, and by sheathing the insulative annular sleeve on the neutral wire pin and the neutral wire, the neutral wire pin contacting with the neutral wire to form a closed path; the insulative annular sleeve being damaged when overheat, allowing the live wire pin to be opened relative to the live wire and the neutral wire pin to be opened relative to the neutral wire by an elastic force between the live wire pin and the live wire as well as between the neutral wire pin and the neutral wire, thereby forming an open circuit.

8. The plug according to claim 7, wherein the thickness of one of the two connecting parts is 0.7 cm.

9. The plug according to claim 7, wherein the thickness of each stopping part is not smaller than the thickness of each connecting part.

10. The plug according to claim 7, wherein a middle section of one of the two connecting parts is formed with an indented concave part, and the thickness at the location of the concave part of the connection part is between 0.1 cm and 1.2 cm.

11. The plug according to claim 7, wherein an end part of the one of the two stopping parts is formed with a guide-in part which enlarges gradually.

12. The plug according to claim 7, wherein an exterior side of one of the two stopping parts is formed with a protruded abutting part.

13. The plug according to claim 7, wherein the live wire pin extends along a direction same as a direction along with the live wire extends, and the neutral wire pin extends along a direction same as a direction along which the neutral wire extends.

14. The plug according to claim 7, wherein the live wire pin extends along a direction perpendicular to the direction along which the live wire extends, the live wire pin or the live wire is provided with a bent extension plate, and the insulative annular sleeve is sheathed on the bent extension plate; the neutral wire pin extending along a direction perpendicular to the direction along which the neutral wire extends, the neutral wire pin or the neutral wire being provided with a bent extension plate and the insulative annular sleeve being sheathed on the bent extension plate.

15. A socket using the hot melt insulation fixing plate according to claim 1, comprising an insulative body which is provided with a set of opposite live wire receptacle and neutral wire receptacle, a live wire terminal which is disposed inside the insulative body and corresponds to the live wire receptacle, a neutral wire terminal which is disposed inside the insulative body and corresponds to the neutral wire receptacle, a live wire which corresponds to the live wire terminal, a neutral wire which corresponds to the neutral wire terminal, and an insulative annular sleeve, with that the insulative annular sleeve is provided with two opposite stopping parts and two opposite connecting parts to connect the two stopping parts, the two stopping parts and the two connecting parts commonly define a holding space, and at least one of the two connecting parts is in the thickness of 0.1˜1.2 cm; by sheathing the insulative annular sleeve on the live wire terminal and the live wire, the live wire terminal contacting with the live wire to form a closed path, and by sheathing the insulative annular sleeve on the neutral wire terminal and the neutral wire, the neutral wire terminal contacting with the neutral wire to form a closed path; the insulative annular sleeve being damaged when overheat, allowing the live wire terminal to be opened relative to the live wire and the neutral wire terminal to be opened relative to the neutral wire by an elastic force between the live wire terminal and the live wire as well as between the neutral wire terminal and the neutral wire, thereby forming an open circuit.

16. The socket according to claim 15, wherein the thickness of one of the two connecting parts is 0.7 cm.

17. The socket according to claim 15, wherein the thickness of each stopping part is not smaller than the thickness of each connecting part.

18. The socket according to claim 15, wherein a middle section of one of the two connecting parts is formed with an indented concave part and the thickness at the location of the concave part of the connecting part is between 0.1 cm and 1.2 cm.

19. The socket according to claim 15, wherein an end part of the one of the two stopping parts is formed with a guide-in part which enlarges gradually.

20. The socket according to claim 15, wherein an exterior side of one of the two stopping parts is formed with a protruded abutting part.
